(19) United States
(12) Patent Application Publication
(10) Pub. No.: US 2018/0054739 A1
(43) Pub. Date: Feb. 22, 2018

(54) SYSTEMS AND METHODS FOR WIRELESS TRANSMISSION DURING CHANNEL AVAILABILITY CHECK ON MIXED DFS CHANNELS

(71) Applicant: QUALCOMM Incorporated, San Diego, CA (US)

(72) Inventors: Rohan Dutta, Kolkata (IN); Abhijit Pradhan, Chennai (IN)

(21) Appl. No.: 15/243,456

(22) Filed: Aug. 22, 2016

(51) Int. Cl. H04W 16/14; H04W 72/04

(52) U.S. Cl. CPC H04W 16/14; H04W 72/0453

(57) ABSTRACT

Systems, methods, and apparatuses for wireless transmission during Channel Availability Check on mixed DFS channels are provided. One aspect of this disclosure provides a method of wireless communication. The method includes identifying, at a first device, a plurality of subchannels of the transmission channel for transmission, the identified plurality of subchannels including one or more restricted subchannels and including one or more unrestricted subchannels. The method further includes determining, at the first device, a first bandwidth configuration for the identified restricted subchannels and a second bandwidth configuration for the identified unrestricted subchannels. The method further includes scanning, at the first device, for one or more restricted signals over one or more of the identified restricted subchannels. The method further includes transmitting, at the first device, a beacon to a second device within a duration of the scanning, the beacon being transmitted over one or more of the identified unrestricted subchannels.

### BACKGROUND

### Field

The present application relates generally to wireless communications, and more specifically to systems, methods, and devices for wireless transmission during Channel Availability Check (CAC) on mixed Dynamic Frequency Selection (DFS) channels.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The prevalence of multiple wireless networks may cause interference, reduced throughput (for example, because each wireless network is operating in the same area and/or spectrum), and/or prevent certain devices from communicating. Under certain conditions, communication over wireless networks may be prohibited and/or temporarily suspended due to government regulations, further preventing devices from communicating. Thus, improved systems, methods, and devices for communicating when wireless networks are densely populated, have interference, and/or are hindered by government regulations are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of the present application provides a method of wireless communication. The method comprises identifying, at a first device, a plurality of subchannels of a transmission channel for transmission, the identified plurality of subchannels including one or more restricted subchannels and including one or more unrestricted subchannels. The method further comprises determining, at the first device, a first bandwidth configuration for the identified restricted subchannels and a second bandwidth configuration for the identified unrestricted subchannels. The method further comprises scanning, at the first device, for one or more restricted signals over one or more of the identified restricted subchannels. The method further comprises transmitting, at the first device, a beacon to a second device within a duration of the scanning, the beacon being transmitted over one or more of the identified unrestricted subchannels.

Another aspect of the present application provides an apparatus for wireless communication over a transmission channel. The apparatus comprises a signal detector. The apparatus further comprises a processor. The processor is configured to identify a plurality of subchannels of the transmission channel for transmission, the identified plurality of subchannels including one or more restricted subchannels and including one or more unrestricted subchannels. The processor is further configured to determine a first bandwidth configuration for the identified restricted subchannels and a second bandwidth configuration for the identified unrestricted subchannels. The processor is further configured to scan, by the signal detector, for one or more restricted signals over one or more of the identified restricted subchannels. The apparatus further comprises a transmitter. The transmitter is configured to transmit a beacon to a wireless device within a duration of the scan, the beacon being transmitted over one or more of the identified unrestricted sub channels.

Yet another aspect of the present application provides an apparatus for wireless communication. The apparatus comprises means for detecting signals. The apparatus further comprises means for identifying, at a first device, a plurality of subchannels of a transmission channel for transmission, the identified plurality of subchannels including one or more restricted subchannels and including one or more unrestricted subchannels, the means for identifying further determining, at the first device, a first bandwidth configuration for the identified restricted subchannels and a second bandwidth configuration for the identified unrestricted subchannels, and the means for identifying further scanning, by the means for detecting signals, for one or more restricted signals over one or more of the identified restricted subchannels. The apparatus further comprises means for transmitting, at the first device, a beacon to a second device within a duration of the scanning, the beacon being transmitted over one or more of the identified unrestricted sub channels.

Yet another aspect of the present application provides a non-transitory computer-readable medium comprising code that, when executed, causes an apparatus to perform a method, the method comprising identifying, at a first device, a plurality of subchannels of a transmission channel for transmission, the identified plurality of subchannels including one or more restricted subchannels and including one or more unrestricted subchannels. The method further comprises determining, at the first device, a first bandwidth configuration for the identified restricted subchannels and a second bandwidth configuration for the identified unrestricted subchannels. The method further comprises scanning, by the first device, for one or more restricted signals over one or more of the identified restricted subchannels. The method further comprises transmitting, at the first device, a beacon to a second device within a duration of the scanning, the beacon being transmitted over one or more of the identified unrestricted subchannels.

### BRIEF DESCRIPTION OF THE DRAWINGS

FIG. 1 illustrates a wireless communication system in which aspects of the present disclosure can be employed.

FIG. 2 is a functional block diagram of a wireless device that can be employed within the wireless communication systems disclosed herein.

FIG. 3 is a flowchart of a legacy method for wireless communication.

FIG. 4 is a time sequence diagram of a portion of the legacy method for wireless communication described with respect to FIG. 3.

FIG. 5 is a flowchart of a method for wireless communication, in accordance with an implementation.

FIG. 6 is a time sequence diagram of a portion of the method for wireless communication described with respect to FIG. 5.

FIG. 7 is a flowchart of a method for wireless communication, in accordance with an implementation.

FIG. 8 is a flowchart of a method for wireless communication, in accordance with an exemplary embodiment.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to a high-efficiency 802.11 protocol using orthogonal frequency-division multiplexing (OFDM), direct-sequence spread spectrum (DSSS) communications, a combination of OFDM and DSSS communications, or other schemes. Implementations of the high-efficiency 802.11 protocol may be used for Internet access, sensors, metering, smart grid networks, or other wireless applications. Advantageously, aspects of certain devices implementing this particular wireless protocol may consume less power than devices implementing other wireless protocols, may be used to transmit wireless signals across short distances, and/or may be able to transmit signals less likely to be blocked by objects, such as humans.

In some implementations, a WLAN includes various devices which are the components that access the wireless network. For example, there may be two types of devices: access points (“AP”) and clients (also referred to as stations, or “STA”). In general, an AP serves as a hub or base station for the WLAN and a STA serves as a user of the WLAN. For example, a STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area networks. In some implementations an STA may also be used as an AP.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency-Division Multiple Access (OFDMA) systems, Single-Carrier

Frequency-Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency-division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal (“UT”), an access terminal (“AT”), a subscriber station, a subscriber unit, a mobile station, a remote station, a remote terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Wireless devices utilize wireless networks to communicate with other wireless devices and to increase connectivity, flexibility, and speed. Many wireless devices connect to wireless networks according to a 802.11 protocol (for example, 802.11a, 802.11b, 802.11g, 802.11n, 802.11ac, 802.11ah, etc.). Furthermore, wireless devices can connect to wireless networks at different frequencies (also known as “bandwidths”). Two commonly used frequencies include 2.4 GHz and 5 GHz.

As the capabilities of modern wireless devices have increased, the operating limitations of the 2.4 GHz bandwidth have caused an increase in demand for connecting modern wireless devices to the more capable 5 GHz bandwidth. Furthermore, some wireless technology protocols utilize the 5 GHz spectrum exclusively (e.g., 802.11 AC).

Governments also utilize the 5 GHz spectrum, for example, with respect to the transmission of radar signals (historically referred to as “RADAR”). Such utilizations can be related to military, aircraft, and/or weather-based communications, among other usages. Certain government regulations restrict certain wireless communications over at least portions of the 5 GHz spectrum. For example, non-government devices may be prohibited from using portions of a 5 GHz network when radar signals are present. Furthermore, more stringent regulations exist in the presence of certain variations of radar (e.g., in the presence of weather radar).

The nature of wireless technologies allows for many users to share the range of frequencies. A range of bandwidths or frequencies may be referred to individually or collectively as a “spectrum” or “spectrums,” e.g., 5.250 GHz to 5.350 GHz. Certain ranges of bandwidths or frequencies may be subdivided into channels of varying widths. For example, common channel widths related to the 5 GHz spectrum include 20 MHz, 40 MHz, 80 MHz, and 160 MHz. Modern wireless devices can transmit over multiple channels (or subchannels) at once to increase communication quality and/or to communicate with multiple other devices at the same time. For example, a wireless access point could operate at a 20 MHz bandwidth over eight channels at once, utilizing a total of 160 MHz of bandwidth to communicate with eight different other wireless devices (e.g., laptops). Similarly, such a wireless access point could operate over four 40 MHz channels at the same time, utilizing the same total of 160 MHz of bandwidth.

To that end, a wireless device can utilize channel identification (e.g., selection) procedures to identify and connect to a number of different channels. Wireless devices may perform channel identification based on various network or device specifications, while other wireless devices may perform channel identification in a random nature. For example, a wireless device performing a 5 GHz-based channel identification (e.g., a 802.11ac-based wireless access point at boot up) could identify eight 20 MHz subchannels of a 160 MHz channel (e.g., in accordance with a multiple-in-multiple-out (MIMO) communication). In this example, the eight 20 MHz subchannels may also be referred to as “HT20 subchannels,” where HT refers to high throughput. Similarly, a full 160 MHz channel (e.g., the 36 VHT 160 channel) can be referred to as a “VHT 160 channel,” where VHT refers to very high throughput. To the extent a wireless device capable of communicating at 160 MHz of bandwidth (e.g., a 802.11 AC-based access point) fails to connect to, or is delayed in the connection to, the entirety of a 160 MHz bandwidth, the full capability of the wireless device may not be achieved. For example, if such a wireless device were communicating over only four 20 MHz subchannels, or over only a single 80 MHz subchannel, 80 MHz of potential bandwidth usage would be going unused.

Furthermore, when wireless devices utilize the entirety of a 160 MHz bandwidth, based on the present bandwidth configuration of the wireless device, the wireless device can be said to be operating at a single, contiguous 160 MHz bandwidth or at one of many non-contiguous bandwidth variations thereof, e.g., at an “80+80 MHz” bandwidth or a “40+40+40+40 MHz” bandwidth, etc. When the wireless device sends connection advertisements (e.g., beacons, which may typically be sent every 100 ms) to potential connecting devices (e.g., a “STA,” a “user,” etc.), the wireless device will typically include an indication of such a bandwidth configuration in the beacon, among other information. In this way, for example, the STA receiving the beacon may determine if the wireless device is connectable and is capable of providing sufficient bandwidth for the STA. For example, certain wireless devices may only be capable of communicating over channels of up to 20 MHz (e.g., 802.11a/b/g devices) or of up to 40 MHz (e.g., 802.11n devices). Certain other wireless devices may be capable of communicating over channels of up to 80 MHz and/or 160 MHz (e.g., 802.11ah devices).

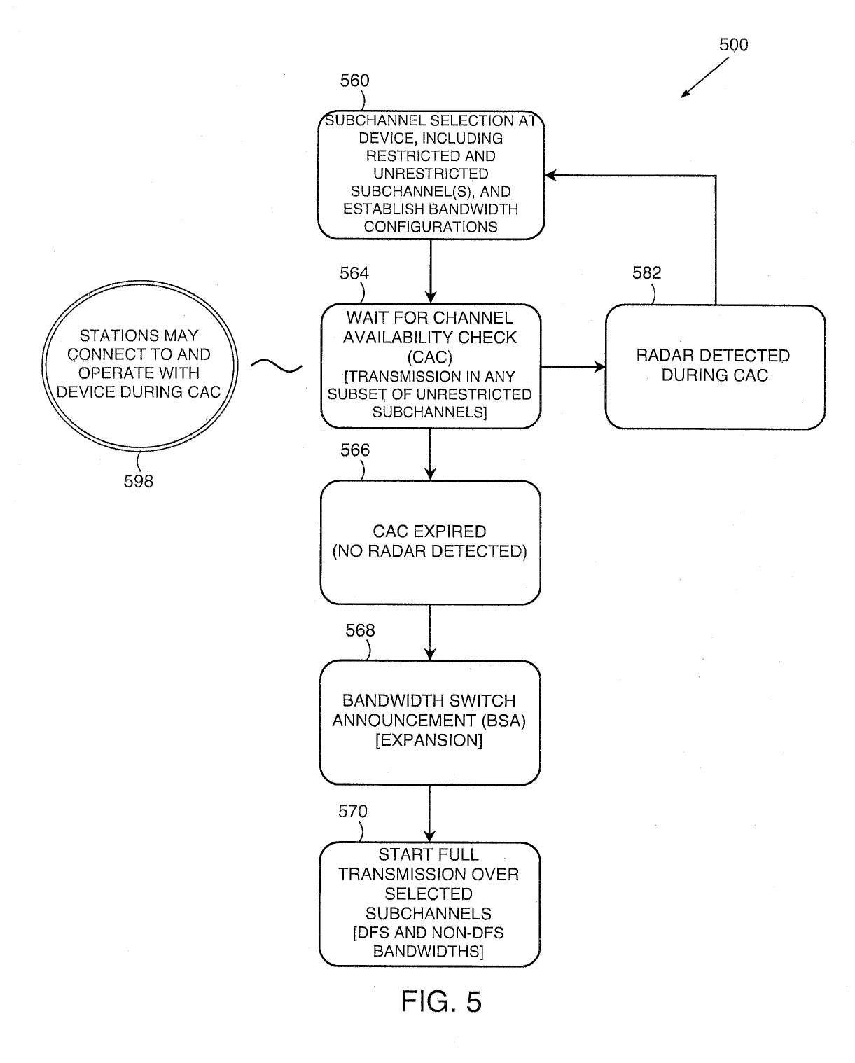

When utilizing the entirety of the 160 MHz bandwidth, a wireless device may be communicating at a contiguous 160 MHz or at a noncontiguous 80+80 MHz, depending on the configuration initiated by the wireless device. Data throughput may be the same in either configuration. Such configurations may also be referred to as bandwidth configurations, modes, bandwidth modes, etc. The wireless device may switch from operating in a 160 MHz mode or in a 80+80 MHz mode to operating in a single 80 MHz mode or in a 40+40 MHz mode, for example. In either such change, the maximum bandwidth throughput that the wireless device may be capable of decreases from 160 MHz to 80 MHz. Such a decrease in bandwidth utilization may be referred to as a bandwidth “step down” or “contraction.” For example, the wireless device may be forced to initiate a bandwidth step down in the event that previously available channels have become unavailable or prohibited from communication. In contrast, the wireless device may switch from operating in, for example, a single 80 MHz mode or in a 40+40 MHz mode to operating in a 160 MHz mode or in a 80+80 MHz mode. In these cases, the maximum bandwidth throughput that the wireless device may be capable of increases from 80 MHz to 160 MHz. Such an increase in bandwidth utilization may be referred to as a bandwidth “step up” or “expansion.” For example, the wireless device may initiate a bandwidth step up if previously unavailable or prohibited channels become available for communication. In accordance with an embodiment, when implementing bandwidth step ups or step downs, the wireless device may notify another device or devices (e.g., a STA or STAs) of the change. In one embodiment, the wireless device may notify other devices of the change in a beacon, for example a beacon that includes a Bandwidth Switch Announcement (BSA), as further discussed below with respect to FIG. 5.

The Federal Communications Commission (FCC) implements certain Dynamic Frequency Selection (i.e., “DFS”) procedures for wireless devices that perform channel identification on 5 GHz channels. A channel that could include radar is called a “DFS channel” (or “DFS subchannel,” “restricted channel,” or “restricted subchannel,” as used herein), and a channel that could not include radar (i.e., a channel that the government does not reserve for radar signaling) is called a “non-DFS channel” (or “non-DFS subchannel,” “unrestricted channel,” or “unrestricted subchannel,” as used herein). A channel that includes both DFS and non-DFS channels is referred to as a “mixed DFS” channel. When a wireless device identifies (e.g., selects) a DFS channel or a mixed DFS channel, DFS procedures mandate that the wireless device perform a scan of the DFS or mixed DFS channel to determine if any radar signals are present on the channel before connecting. This scan is called a Channel Availability Check or “CAC.” The required CAC duration is 60 seconds for DFS channels that are reserved for “regular radar” (e.g., subchannels 52HT20, 56HT20, 60HT20, 64HT20 of the 36 VHT 160 channel, among others). The required CAC duration is 600 seconds for DFS channels that are reserved for “weather radar” (e.g., subchannel 124 of the 36 VHT 160 subchannel, among others). Example non-DFS subchannels over the 36 VHT 160 mixed DFS channel include subchannels 36, 40, 44, and 48 (i.e., 36HT20, 40HT20, 44HT20, and 48HT20, respectively). Further information regarding reserved DFS and non-DFS channel allocation, for example, for a North American 802.11ac channel, and with respect to FCC domains (UNII-1, UNII-2, etc.), Weather Radar channels, Doppler Radar channels, specific channel frequencies, and variations of channel widths is published at: http://www.mirazon.com/whats-802-11ac-keep-hearing/

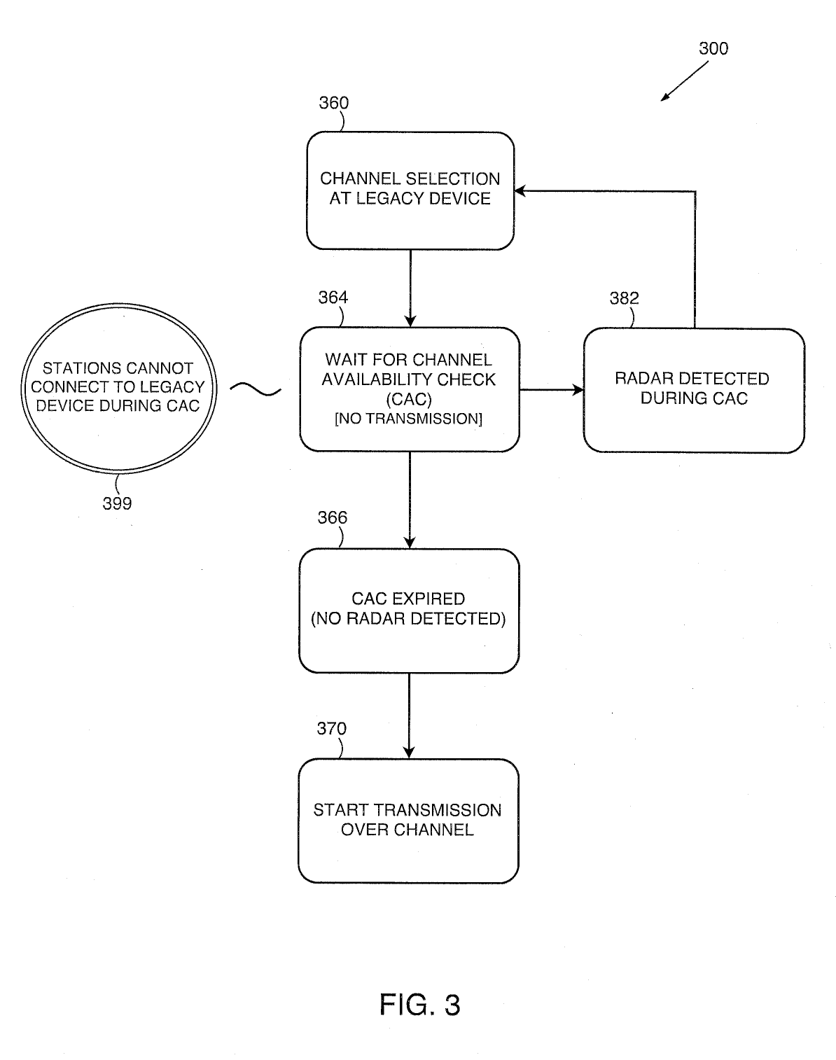

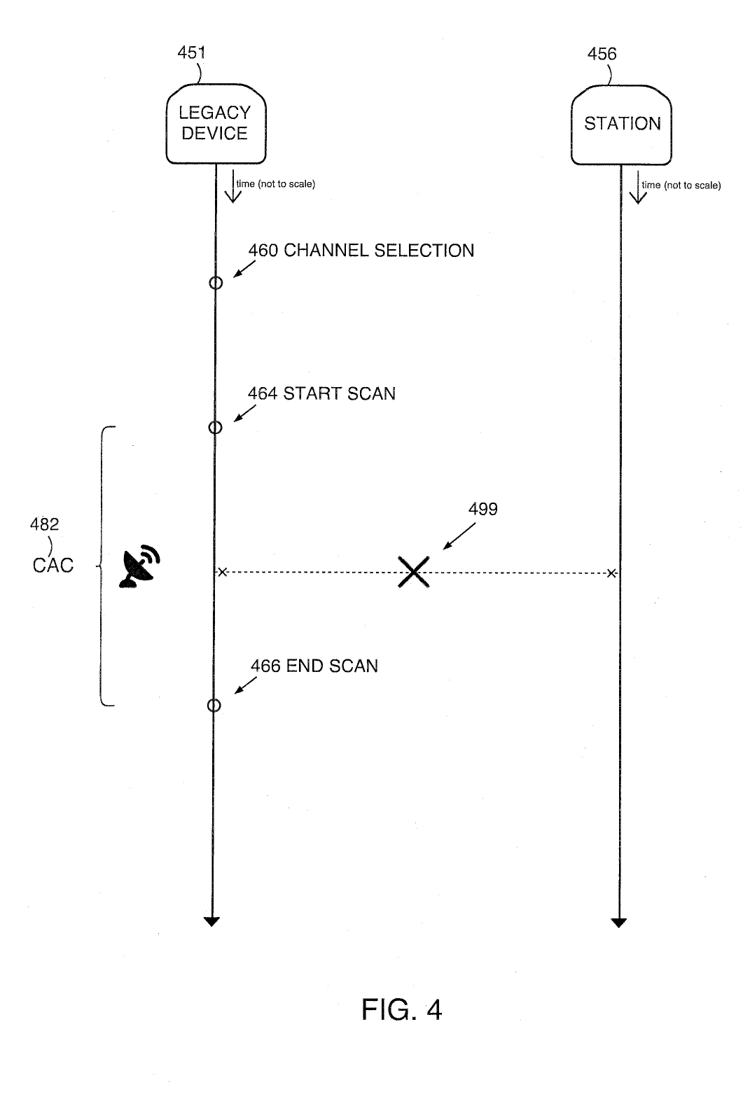

If a wireless device does not detect any radar signals on the DFS or mixed DFS channel during the CAC (e.g., the CAC “expires”), the wireless device is permitted to communicate over the entire DFS or mixed DFS channel. However, if the wireless device detects radar on the DFS or mixed DFS channel during the CAC, the wireless device must refrain from communicating over the channel for a 30 minute wait duration, e.g., the channel is put on a non-occupancy list (NOL) for the duration. Traditionally, a legacy wireless device in this scenario will choose a different channel and run another CAC, repeating this process until a CAC expires without radar detection. The legacy wireless device will have no communication with STAs until at least one CAC expires without radar detection, as further discussed below with respect to FIGS. 3 and 4.

If a wireless device does not detect radar during a CAC and begins to communicate over the scanned channel, DFS regulations require that the wireless device continue to “monitor” for radar, which may be referred to as “in-service monitoring” or “ISM.” If a wireless device detects radar during in-service monitoring, the detected radar may be referred to as “non-CAC radar.” If the wireless device detects non-CAC radar, similarly, regulations require that the channel be blacklisted (i.e., added to the NOL), and the wireless device must refrain from communicating over such channel for 30 minutes. Traditionally, a legacy wireless device in a non-CAC radar detection scenario will stop all communications, choose a different channel, and run another CAC, repeating this process until another CAC expires without radar detection. That is, the legacy wireless device will have no further communication with STAs until at least one CAC expires without radar detection. Such network restrictions result in slowdown and wasted resources for the wireless device, the network on which the wireless device is connected, and any wireless device that would otherwise connect to and communicate with the wireless device.

Thus, when wireless devices connect to mixed DFS channels (e.g., the 36 VHT 160 channel), aspects of the present disclosure enable such wireless devices to transmit over at least a portion of the mixed DFS channel (e.g., over the non-DFS subchannels), even while the wireless device scans for radar (e.g., during a CAC). To that end, systems and methods for wirelessly transmitting (e.g., via any subset of non-DFS subchannel bands on the mixed DFS channel) in parallel with listening for and/or receiving radar pulses in the entire bandwidth during a CAC are provided herein. As such, the enabled wireless device may provide uninterrupted service to STAs in parallel with performing a CAC on a mixed DFS channel.

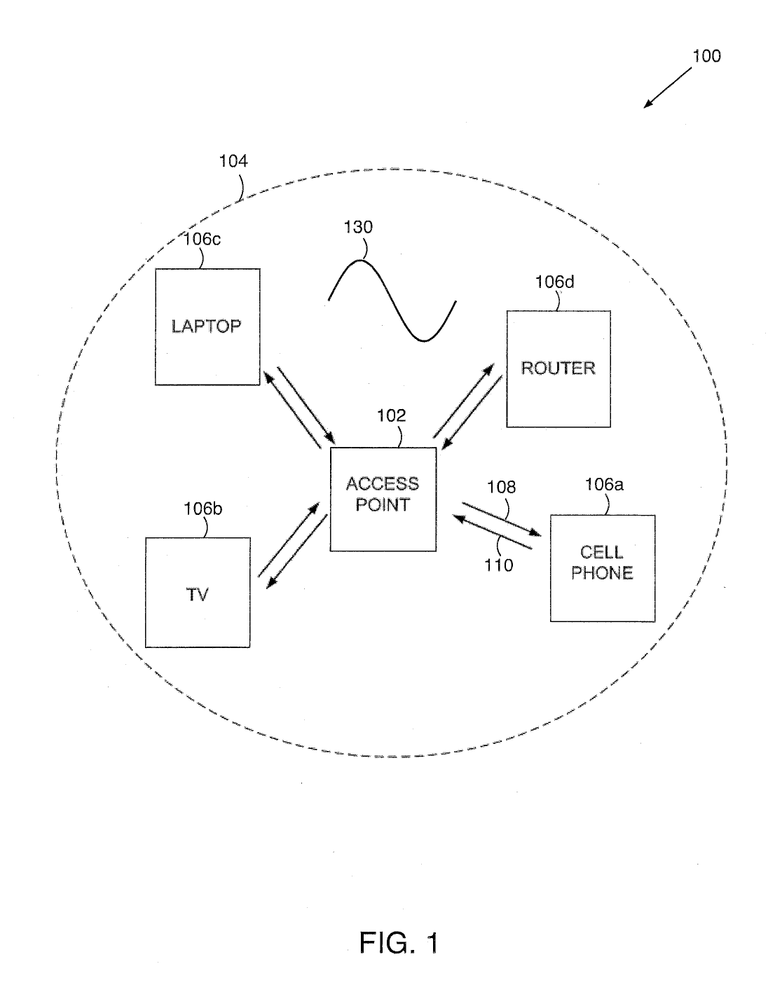

FIG. 1 illustrates a wireless communication system 100 in which aspects of the present disclosure can be employed. The wireless communication system 100 may operate pursuant to a wireless standard, for example a 802.11ac standard. The wireless communication system 100 may include an AP 102, which communicates with STAs 106a, 106b, 106c, and/or 106d (also individually or collectively referred to as “STA” or “STAs”). The AP 102 may also communicate with additional STAs (not pictured). The STAs may also individually or collectively operate as an AP, or vice versa.

A variety of processes and methods can be used for transmissions in the wireless communication system 100 between the AP 102 and the STAs 106. For example, signals can be sent and received between the AP 102 and the STAs 106 in accordance with OFDM/OFDMA techniques. If this is the case, the wireless communication system 100 can be referred to as an OFDM/OFDMA system. Alternatively, signals can be sent and received between the AP 102 and the STAs 106 in accordance with code division multiple access (CDMA) techniques. If this is the case, the wireless communication system 100 can be referred to as a CDMA system.

A communication link that facilitates transmission from the AP 102 to one or more of the STAs 106 can be referred to as a downlink 108, and a communication link that facilitates transmission from one or more of the STAs 106 to the AP 102 can be referred to as an uplink 110. Alternatively, a downlink 108 can be referred to as a forward link or a forward channel, and an uplink 110 can be referred to as a reverse link or a reverse channel. The AP 102 may connect to one or more channels so as to communicate with the STAs 106. The AP 102 may perform a channel identification procedure prior to connecting to one or more of the channels. The channel identification procedure and/or the channel connections may be subject to and operate in accordance with certain government regulations, e.g., DFS radar regulations, as discussed above.

The AP 102 may act as a base station and provide wireless communication coverage in a basic service area 104. The AP 102 along with the STAs 106 associated with the AP 102 and that use the AP 102 for communication can be referred to as a basic service set (BSS). It should be noted that the wireless communication system 100 may not have a central AP, but rather may function as a peer-to-peer network between the STAs 106. Accordingly, the functions of the AP 102 described herein may alternatively be performed by one or more of the STAs 106.

In some aspects, a STA 106 can be required to associate with the AP 102 in order to send communications to and/or receive communications from the AP 102. In one aspect, information for associating is included in a broadcast by the AP 102 (e.g., in a beacon; not pictured). To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 102. In some aspects, the AP 102 may use backhaul services, for example, to communicate with a larger network, such as the Internet or a public switched telephone network (PSTN).

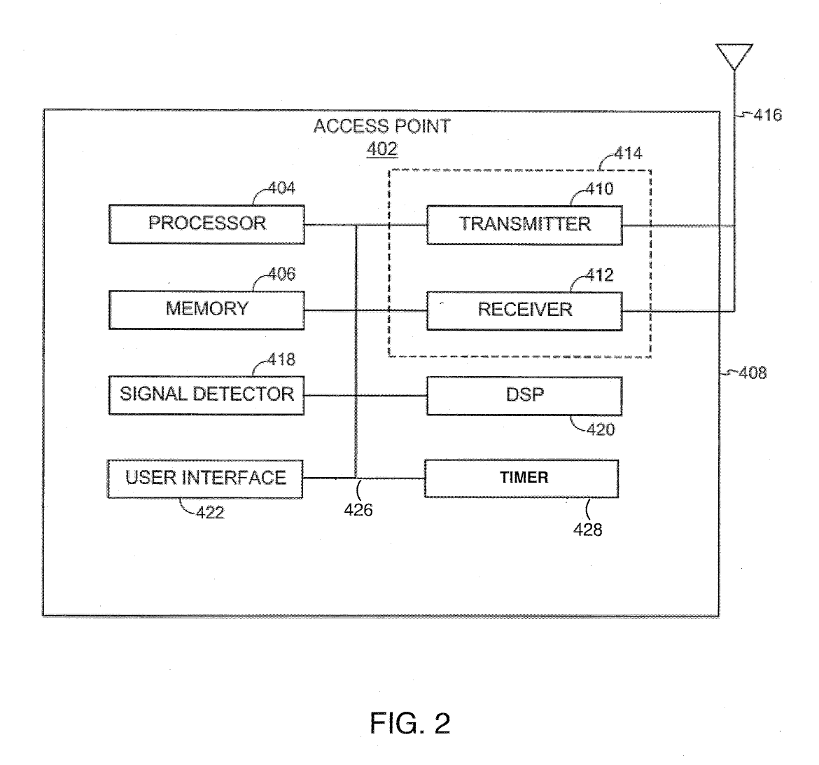

In an embodiment, the AP 102 includes an 802.11 AC-based access point for connecting to a mixed DFS channel. The AP 102 may perform some or all of the operations described herein to enable communications between the AP 102 and the STAs 106 using the 802.11. The functionality of some implementations of the AP 102 is described in greater detail below with respect to FIGS. 2 and 5-8.

Alternatively or in addition, the STAs 106 may perform some or all of the operations described herein to enable communications between the STAs 106 and the AP 102 using the 802.11 protocol.

In some circumstances, a basic service area can be located near other basic service areas. For example, although not pictured, the wireless communication system 100 can include multiple wireless communication networks. The basic service areas of such networks can be physically located near each other. Despite the close proximity of the basic service areas, the APs and/or STAs may each communicate using the same spectrum (e.g., 5 GHz). Thus, if a device in one basic service area (for example, one that is transmitting a radar signal, for example, a radar signal 130) is transmitting data, devices outside that basic service area (for example, the AP 102) may sense the communication (e.g., the radar signal 130) on the medium.

FIG. 2 shows a functional block diagram of an AP 402 that can be employed within the wireless communication system 100 of FIG. 1. The AP 402 is an example of a device that can be configured to implement the various methods described herein. For example, the AP 402 may comprise the AP 102 and/or one of the STAs 106.

The AP 402 may include a processor 404 which controls operation of the AP 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 typically performs logical and arithmetic operations based on program instructions stored within the memory 406. The instructions in the memory 406 can be executable to implement the methods described herein.

The processor 404 may comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (for example, in source code format, binary code format, executable code format, or any other suitable format of code). The instructions, when executed by the one or more processors, cause the processing system to perform the various functions described herein.

The AP 402 may also include a housing 408 that may include a transmitter 410 and/or a receiver 412 to allow transmission and reception of data between the AP 402 and a remote location. The transmitter 410 and receiver 412 can be combined into a transceiver 414. An antenna 416 can be attached to the housing 408 and electrically coupled to the transceiver 414. The AP 402 may also include (not shown) multiple transmitters, multiple receivers, multiple transceivers, and/or multiple antennas.

The AP 402 may also include a signal detector 418 that can be used in an effort to detect and quantify the level of signals received by the transceiver 414. The signal detector 418 may detect such signals as total energy, energy per subcarrier per symbol, power spectral density, radar signals, and other signals. The AP 402 may also include a timer 428 that can be used together with the signal detector 418 to detect signals. For example, the signal detector 418 may scan for radar signals for a CAC duration in accordance with the timer 428. Similarly, the AP 402 may disable communications with one or more network channels according to a NOL blacklist for a duration in accordance with the timer 428. The AP 402 may also include a digital signal processor (DSP) 420 for use in processing signals. The DSP 420 can be configured to generate a packet for transmission. In some aspects, the packet may comprise a physical layer data unit (PPDU). In some aspects, the packet may comprise a beacon.

The AP 402 may further comprise a user interface 422 in some aspects. The user interface 422 may comprise a keypad, a microphone, a speaker, and/or a display. The user interface 422 may include any element or component that conveys information to a user of the AP 402 and/or receives input from the user.

The various components of the AP 402 can be coupled together by a bus system 426. The bus system 426 may include a data bus, for example, as well as a power bus, a control signal bus, and a status signal bus in addition to the data bus. Those of skill in the art will appreciate the components of the AP 402 can be coupled together or accept or provide inputs to each other using some other mechanism.

Although a number of separate components are illustrated in FIG. 2, those of skill in the art will recognize that one or more of the components can be combined or commonly implemented. For example, the processor 404 can be used to implement not only the functionality described above with respect to the processor 404, but also to implement the functionality described above with respect to the signal detector 418, the timer 428, the memory 406, the transceiver 414, the transmitter 410, the receiver 412, and/or the DSP 420, etc. Further, each of the components illustrated in FIG. 2 can be implemented using a plurality of separate elements.

The AP 402 may comprise an AP 102 and/or a STA 106 and can be used to transmit and/or receive communications. That is, either the AP 102 or the STA 106 may serve as a transmitter or receiver device.

FIG. 3 is a flowchart of a legacy method 300 for wireless communication. The legacy method 300 may be performed by a legacy device, for example, a legacy AP that does not include the benefits described in the present disclosure. At step 360, the legacy AP performs channel identification. For example, the legacy AP may identify a mixed DFS channel for connection, e.g. the 36 VHT 160 MHz channel. Then at step 364, according to government regulations, the legacy AP performs a CAC over the mixed DFS channel. During the CAC, STAs cannot connect to the legacy AP, as indicated in block 399. If the legacy AP detects radar during the CAC at step 382, then the legacy AP may return to step 360 to perform another channel identification and then another CAC at step 364. At step 366, if the legacy AP does not detect radar by the expiration of the CAC, then at step 370, the legacy AP may begin transmission over the entire mixed DFS channel.

FIG. 4 is a time sequence diagram of a portion of the legacy method 300 for wireless communication described with respect to FIG. 3, which may be performed by a legacy AP 451 that does not include the benefits described in the present disclosure. At time 460, the legacy AP 451 performs channel identification. For example, the legacy AP 451 may identify a mixed DFS channel for connection, e.g. the 36 VHT 160 MHz channel. Then at time 464, according to government regulations, the legacy AP 451 begins a CAC 482 over the mixed DFS channel. The CAC 482 ends at time 466, where the duration of the CAC 482 is indicated by a bracket. During the CAC 482, STAs (e.g., the illustrated STA 456) cannot connect to the legacy AP 451, and vice versa, as indicated by the no-communication indicator 499.

FIG. 5 is a flowchart of a method 500 for wireless communication, in accordance with an implementation. The method 500 may be performed by an AP, for example, the AP 102 or the AP 402 discussed above with respect to FIGS. 1 and 2. In some aspects, the AP 402 may perform, or otherwise enable, one or more steps of method 500 in connection with one or more of the various components of the AP 402, e.g., the processor 404, the memory 406, the signal detector 418, the timer 428, the transceiver 414, the transmitter 410, the receiver 412, etc.

In an embodiment, the AP 402 may comprise an 802.11ac-based wireless device that identifies (e.g., selects) a 5 GHz mixed DFS channel (e.g., the 36 VHT 160 MHz channel) for connection. In one embodiment, the AP 402 may be booting up at the start of the method 500, or in other embodiments, the AP 402 may already be operating at the start of the method 500. In certain of the embodiments in which the AP 402 is already operating, the AP 402 may be transmitting in accordance with one of many bandwidth modes, e.g., a 160 MHz mode, an 80+80 MHz mode, an 80 MHz mode, a 40+40 MHz mode, etc., as discussed above. In some embodiments, the AP 402 may be connecting to the mixed DFS channel for the first time at the start of the method 500, and in other embodiments, the AP 402 may already be connected to the mixed DFS channel at the start of the method 500.

At step 560, the AP 402 may perform subchannel identification on the mixed DFS channel. For example, the AP 402 may randomly identify subchannels on the mixed DFS channel, or the AP 402 may identify subchannels based on various parameters (e.g., an amount of traffic on a subchannel). The AP 402 may identify at least one restricted subchannel (e.g., a DFS subchannel) and at least one unrestricted subchannel (e.g., a non-DFS subchannel). In this example, the AP 402 identifies four restricted subchannels and four unrestricted subchannels (i.e., eight HT20 subchannels).

The AP 402 may establish (e.g., determine) different bandwidth configurations for the identified (e.g., selected) restricted and unrestricted subchannels. For example, the AP 402 may refrain from communicating over the identified restricted subchannels until a CAC procedure is satisfied. In an exemplary embodiment, the AP 402 may communicate over the identified unrestricted subchannels, even while performing the CAC. In one aspect, the AP 402 may initiate a bandwidth mode according to the properties of the identified subchannels. In this example, having identified four restricted subchannels, the AP 402 may reserve half of the 160 MHz bandwidth (i.e., 80 MHz) to perform a CAC, i.e., scan for radar (e.g., the radar signal 130 of FIG. 1). In this example, the AP 402 may then utilize the remaining 80 MHz for communication, e.g., in a 80 MHz mode, a 40+40 MHz mode, etc. In this way, the AP 402 may be said to have established or determined a first bandwidth configuration for the identified restricted subchannels, i.e., a configuration in which the AP 402 refrains from communicating over the restricted subchannels and reserves the appropriate bandwidth for radar scanning. Similarly, the AP 402 may be said to have established or determined a second bandwidth configuration for the identified unrestricted subchannels, i.e. a configuration in which the AP 402 may communicate over the unrestricted subchannels at a bandwidth mode according to the remaining bandwidth.

Thus, at step 564, according to government regulations, the AP 402 performs a CAC (or “scan”) over the mixed DFS channel. In this example, the AP 402 reserves 80 MHz of bandwidth for the scan, and the AP 402 may transmit in any subset of the unrestricted subchannels over the remaining 80 MHz of bandwidth. For example, during the scan, the AP 402 may transmit a beacon over one or more of the unrestricted subchannels to one or more other wireless devices (e.g., one or more of the STAs 106). In one embodiment, the beacon may include connection information for the AP 402 based at least on the above discussed second bandwidth configuration. That is, the beacon may indicate that the AP 402 is operating at, for example, an 80 MHz mode. In this way, one or more STAs 106 that receive the one or more beacons may connect to and operate with the AP 402 via some variation of the 80 MHz mode. In this way, during the scan, the STAs 106 may communicate with the AP 402, as indicated in indicator 598 and in accordance with embodiments of the present disclosure.

At step 566, if the AP 402 does not detect radar by the expiration of the CAC, then in one embodiment, the AP 402 may initiate a bandwidth step up. That is, the AP 402 may initiate an 80+80 MHz mode or a 160 MHz mode for communication over the entire mixed DFS channel. In this way, the AP 402 may be said to have established or determined a third bandwidth configuration for all of the identified subchannels.

Then at step 568, the AP 402 may transmit a bandwidth switch announcement (BSA). For example, the AP 402 may transmit one or more beacons over one or more of the identified unrestricted subchannels, the beacons including at least the BSA. In an aspect, the BSA may include connection information related to the determined third bandwidth configuration, e.g. that the AP 402 is operating at (or, as the case may be, has stepped up to) an 80+80 MHz mode or a 160 MHz mode. When the BSA indicates that the AP 402 has stepped up the bandwidth mode, it can be referred to as a bandwidth “expansion.”

Thus, at step 570, the AP 402 may start full transmission over one or more (or all) of the identified subchannels.

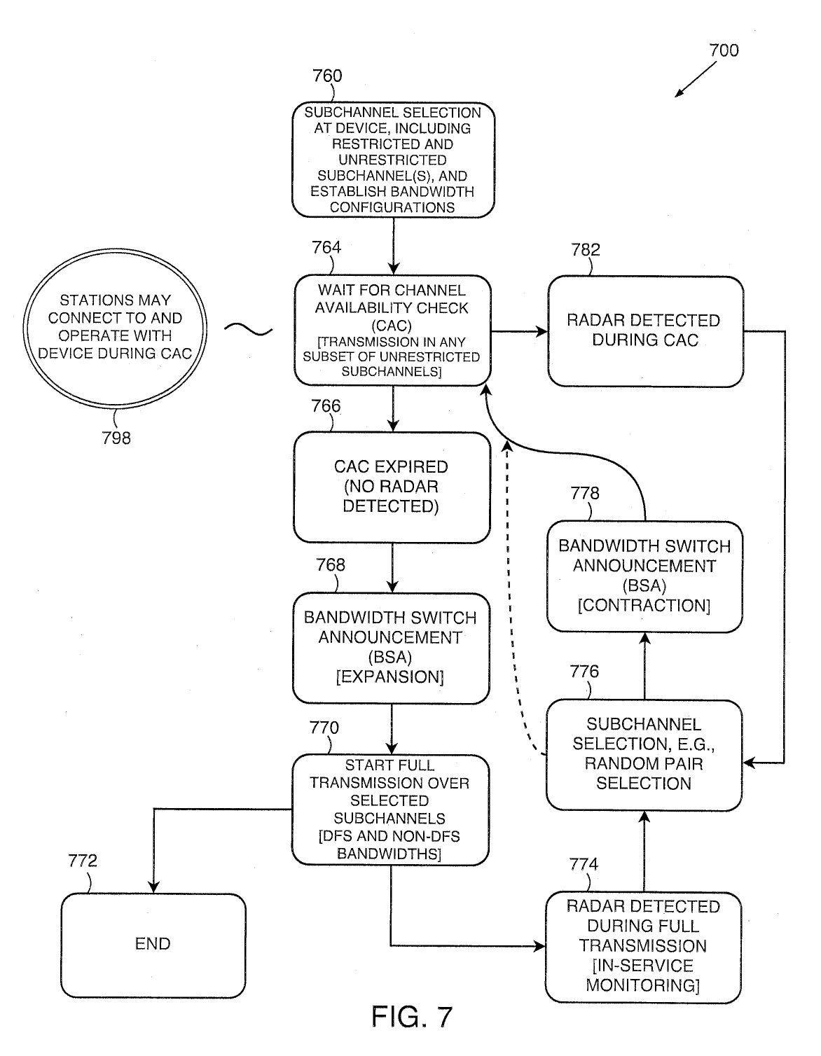

In some embodiments, the AP 402 may detect radar (e.g., the radar signal 130) during the CAC at step 582, and in one embodiment, the AP 402 may then return to step 560 to perform another subchannel identification. Within this time, the AP 402 may maintain communication over the non-DFS subchannels, as further discussed below with respect to FIG. 7.

In some embodiments, the AP 402 may detect non-CAC radar (e.g., the radar signal 130), for example, after starting full transmission at step 570. Similarly, within this time, the AP 402 may maintain communication over the non-DFS subchannels, as further discussed below with respect to FIG. 7.

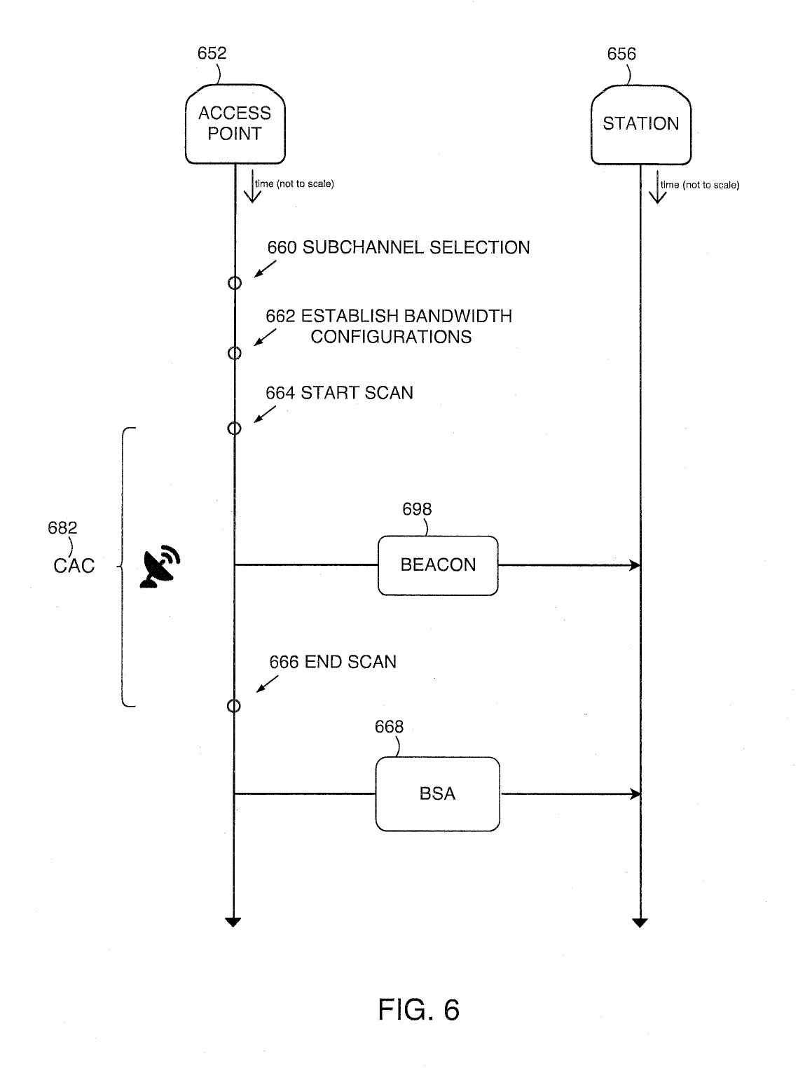

FIG. 6 is a time sequence diagram of a portion of the method 500 for wireless communication described with respect to FIG. 5. The time sequence diagram includes an AP 652, which may comprise the AP 102 and/or the AP 402 discussed above with respect to FIGS. 1, 2, and 5. The time sequence diagram also includes a STA 656, which may comprise one or more of the STAs 106 discussed above with respect to FIGS. 1 and 5.

At time 660, the AP 652 performs subchannel identification on the mixed DFS channel as described above with respect to step 560 of FIG. 5. In this example, the AP 652 identifies at least one restricted subchannel and at least one unrestricted subchannel.

At time 662, the AP 652 determines bandwidth configurations for the identified subchannels as further described above with respect to step 560 of FIG. 5. In this example, the AP 652 determines a first bandwidth configuration for the identified restricted subchannels such that the AP 652 refrains from communicating over such channels, instead reserving 80 MHz (for example) to perform a radar scan. In this example, the AP 652 determines a second bandwidth configuration for the identified unrestricted subchannels such that the AP 652 communicates over the unrestricted subchannels at a 80 MHz (for example) mode.

At time 664, the AP 652 initiates a scan (e.g., a CAC) for detecting one or more restricted signals (e.g., radar) over one or more of the identified restricted subchannels, as described above with respect to FIG. 5. During the CAC 682, STAs (e.g., the STA 656) may communicate with the AP 652. For example, during the CAC 682, the AP 652 may transmit a beacon 698 to the STA 656 over one or more of the identified unrestricted subchannels, as discussed above with respect to step 564 and indicator 598 of FIG. 5. In this way, during the CAC 682, the STA 656 may communicate with the AP 652.

At time 666, the CAC 682 may expire without detection of radar and the AP 652 may then initiate a bandwidth step up, as described above with respect to step 566 of FIG. 5.

Then after the CAC 682, the AP 652 may transmit a BSA 668 to the STA 656, as discussed above with respect to step 568 of FIG. 5. The BSA 668 may be included in a beacon, for example, and may indicate connection information related to the AP 652, such as information regarding the bandwidth step up mentioned above.

In some embodiments, the AP 652 may detect radar (e.g., the radar signal 130 described in connection with FIG. 1) during the CAC 682, and in one embodiment, the AP 652 may then perform another subchannel identification, or may perform different actions, while maintaining communication over the non-DFS subchannels, as further discussed below with respect to FIG. 7.

In some embodiments, the AP 652 may detect non-CAC radar (e.g., the radar signal 130), for example, after the CAC 682, and then perform various actions. Similarly, within this time, the AP 652 may maintain communication over the non-DFS subchannels, as further discussed below with respect to FIG. 7.

FIG. 7 is a flowchart of a method 700 for wireless communication, in accordance with an implementation. The method 700 may be performed by an AP, for example, the AP 102, the AP 402, and/or the AP 652 described above with respect to FIGS. 1, 2, 5, and 6. In some aspects, the AP 402 may perform, or otherwise enable, one or more steps of method 700 in connection with one or more of the various components of the AP 402, e.g., the processor 404, the memory 406, the signal detector 418, the timer 428, the transceiver 414, the transmitter 410, the receiver 412, etc.

The AP 402 may comprise or otherwise operate according to any number of the aspects described with respect to the AP 402 in the description of the method 500 of FIG. 5. Furthermore, indicator 798 and steps 760, 764, 766, 768, 770, and 782 of method 700, may correspond, all or in part, to indicator 598 and steps 560, 564, 566, 568, 570, and 582 of method 500, respectively, described above with respect to FIG. 5.

In some embodiments, the AP 402 may detect radar (e.g., the radar signal 130) during the CAC at step 782, and the AP 402 may then proceed to step 776 to perform a subchannel identification according to one or more subchannel identification embodiments described herein. Within this time, the AP 402 may maintain communication with one or more STAs (e.g., one or more STAs 106 described with respect to FIG. 1) over the non-DFS subchannels.

For example, in one embodiment, the AP 402 may disconnect (e.g., unselect or unidentify) from the one or more restricted subchannels over which radar was detected, e.g., place said subchannels on a NOL. Then, the AP 402 may identify at least one different restricted subchannel. The AP 402 may identify the at least one different restricted subchannels according to a random identification or according to a different type of identification. For example, the AP 402 may identify a different subchannel according to a traffic level of the subchannel. In some embodiments, the AP 402 may also identify one or more different unrestricted subchannels according to a random channel identification or a different type of identification. In some embodiments, the AP 402 may randomly identify one different restricted subchannel and randomly identify one different unrestricted subchannel, which may be referred to as a random pair identification.

When the AP 402 identifies one or more different restricted subchannels and/or unrestricted subchannels, the AP 402 may re-determine, or maintain the determination of, bandwidth configurations accordingly. For example, the AP 402 may determine a first bandwidth configuration for all of the identified restricted subchannels, as described above with respect to step 560 of FIG. 5. As another example, the AP 402 may determine a second bandwidth configuration for all of the identified unrestricted subchannels, as further described above with respect to step 560 of FIG. 5. For example, in some embodiments, the AP 402 may initiate a bandwidth step down when the radar is detected. In other embodiments, the AP 402 may maintain a stepped down bandwidth (e.g., 80 MHz) when the radar is detected.

Returning to step 770, in some embodiments, the AP 402 may not detect any radar (e.g., a radar signal 130 as described with respect to FIG. 1), for example, after starting full transmission at step 770. In this case, the method 700 may be said to end at step 772. Alternatively, the AP 402 may detect non-CAC radar (e.g., the radar signal 130), for example, after starting full transmission at step 770. That is, at step 774, the AP 402 may detect the radar signal 130 during in-service monitoring (ISM). In this case, the AP 402 may also continue to step 776 and perform a subchannel identification according to one or more of the subchannel identification embodiments discussed above.

After the subchannel identification, the AP 402 may then transmit a bandwidth switch announcement (BSA). For example, the AP 402 may transmit one or more second beacons over one or more of the identified unrestricted subchannels, the second beacons including at least the BSA. In an aspect, the BSA may be similar to the BSA described with respect to step 568 of FIG. 5, except that the BSA may indicate that the AP 402 has stepped down the bandwidth mode, and thus, the BSA may be referred to as a bandwidth “contraction.”

In some embodiments, the BSA may be optional when the AP 402 does not step down the bandwidth mode at step 776. For example, the AP 402 may already be operating at a stepped down 80 MHz mode during the CAC at step 764, then detect radar at step 782, then identify one or more new subchannels at step 776, and then return to step 764 to perform a second CAC, each of such steps being performed while maintaining operation at the stepped down 80 MHz mode. Thus, as the bandwidth mode did not change in this scenario, the AP 402 does not send a BSA at step 778, instead continuing directly from step 776 to step 764, as indicated by the dashed arrow.

In an alternative embodiment, at step 776, the AP 402 may not identify any new unrestricted subchannels and may not identify any new restricted subchannels. Instead, the AP 402 may wait a predetermined duration before initiating a second scan (e.g., another CAC) of the same identified restricted subchannels at step 764. The predetermined duration may be a government regulated duration (e.g., 30 minutes), during which the restricted subchannel or subchannels may be placed on a NOL (i.e., blacklisted), as described above. In such an alternative embodiment, within the predetermined duration, the AP 402 may continue to communicate with one or more of the STAs 106 over one or more of the unrestricted subchannels. After the predetermined duration, the AP 402 may then continue directly to step 764 to perform another CAC on the restricted subchannels, as indicated by the dashed arrow.

Thus, continuing from one of steps 776 or 778, at step 764, the AP 402 performs another CAC. The AP 402 may then proceed to step 782 or step 766, depending on the results of the CAC. During the CAC, and during the above described embodiments of method 700, the AP 402 may maintain communication over the identified non-DFS subchannels, for example, by transmitting one or more beacons to one or more of the STAs 106. As such, the AP 402 may provide uninterrupted service to the STAs 106 in parallel with performing one or more CACs on the mixed DFS channel.

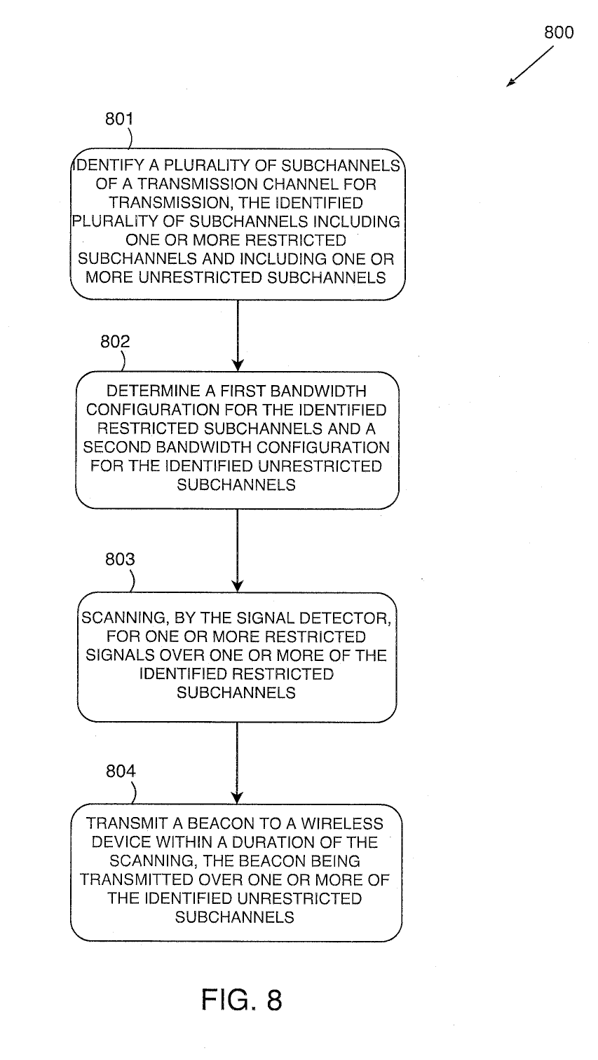

FIG. 8 is a flowchart of a method for wireless communication, in accordance with an exemplary embodiment. The method 800 may be performed by an AP, for example, the AP 102, the AP 402, and/or the AP 652 described above with respect to FIGS. 1, 2, and 5-7. In some aspects, the AP 402 may perform, or otherwise enable, one or more steps of method 700 in connection with one or more of the various components of the AP 402, e.g., the processor 404, the memory 406, the signal detector 418, the timer 428, the transceiver 414, the transmitter 410, the receiver 412, etc.

At step 801, in some aspects, the AP 402 may identify a plurality of subchannels of a transmission channel for transmission, the identified plurality of subchannels including one or more restricted subchannels and including one or more unrestricted subchannels. The AP 402 may perform such aspects in accordance with the descriptions related to step 560, time 660, and/or step 760 of FIGS. 5, 6, and 7, respectively. Furthermore, the AP 402 may perform such aspects in accordance with the descriptions related to step 776 of FIG. 7. In one example, in addition to or in connection with the AP 402, means for performing such aspects may include, for example, the processor 404 of the AP 402, described in connection with FIG. 4 above.

At step 802, in some aspects, the AP 402 may determine a first bandwidth configuration for the identified restricted subchannels and a second bandwidth configuration for the identified unrestricted subchannels. The AP 402 may perform such aspects in accordance with the descriptions related to step 560, time 662, and/or step 760 of FIGS. 5, 6, and 7, respectively. Furthermore, the AP 402 may perform such aspects in accordance with the descriptions related to step 776 of FIG. 7. In one example, in addition to or in connection with the AP 402, means for performing such aspects may include, for example, the processor 404 of the AP 402, described in connection with FIG. 4 above.

At step 803, in some aspects, the AP 402 may scan, by a signal detector, for one or more restricted signals over one or more of the identified restricted subchannels. The AP 402 may perform such aspects in accordance with the descriptions related to step 564, time 664, and/or step 764 of FIGS. 5, 6, and 7, respectively. In one example, in addition to or in connection with the AP 402, means for performing such aspects may include, for example, the signal detector 418 of the AP 402, described in connection with FIG. 4 above.

At step 804, in some aspects, the AP 402 may transmit a beacon to a wireless device within a duration of the scanning, the beacon being transmitted over one or more of the identified unrestricted subchannels. The AP 402 may perform such aspects in accordance with the descriptions related to step 564, beacon 698, and/or step 764 of FIGS. 5, 6, and 7, respectively. In one example, in addition to or in connection with the AP 402, means for performing such aspects may include, for example, the transmitter 410, the receiver 412, and/or the transceiver 414 of the AP 402, described in connection with FIG. 4 above.

As used herein, the term “determining” and/or “identifying” encompass a wide variety of actions. For example, “determining” and/or “identifying” may include calculating, computing, processing, deriving, choosing, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, identifying, establishing, selecting, choosing, determining and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) signal or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an AP 102 and/or another device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an AP 102 and/or another device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication comprising:
identifying, at a first device, a plurality of subchannels of a transmission channel for transmission, the identified plurality of subchannels including one or more restricted subchannels and including one or more unrestricted subchannels;
determining, at the first device, a first bandwidth configuration for the identified restricted subchannels and a second bandwidth configuration for the identified unrestricted subchannels;
scanning, at the first device, for one or more restricted signals over one or more of the identified restricted subchannels; and
transmitting, at the first device, a beacon to a second device within a duration of the scanning, the beacon being transmitted over one or more of the identified unrestricted subchannels.

2. The method of claim 1, further comprising transmitting connection information for the first device in the beacon, the connection information being based at least on the second bandwidth configuration.

3. The method of claim 1, further comprising:
detecting, by the first device, one or more restricted signals over one or more of the identified restricted subchannels within the duration of the scanning;
identifying at least one different restricted subchannel for transmission;
determining the first bandwidth configuration for the identified different restricted subchannels;
scanning, by the first device, for one or more restricted signals over one or more of the identified different restricted subchannels; and
transmitting a second beacon to the second device during the scanning over the one or more of the identified different restricted subchannels, the second beacon being transmitted over one or more of the identified unrestricted subchannels.

4. The method of claim 3, wherein the identification of the at least one different restricted subchannel is based on a random channel identification, and wherein the method further comprises randomly identifying at least one different unrestricted subchannel for transmission.

5. The method of claim 1, further comprising:
detecting, by the first device, one or more restricted signals over one or more of the identified restricted subchannels within the duration of the scanning;
waiting for a predetermined duration;
after waiting the predetermined duration, scanning, by the first device, for one or more restricted signals over one or more of the identified restricted subchannels; and
transmitting a second beacon to the second device within the predetermined duration, the second beacon being transmitted over one or more of the identified unrestricted subchannels.

6. The method of claim 1, wherein if the first device does not detect any restricted signals over any of the identified restricted subchannels, the method further comprising:
determining a third bandwidth configuration for the identified subchannels; and
transmitting one or more beacons over one or more of the identified unrestricted subchannels and over one or more of the identified restricted subchannels.

7. The method of claim 6, further comprising:
subsequently detecting, by the first device, one or more restricted signals over one or more of the identified restricted subchannels; and
identifying at least one different subchannel of the transmission channel.

8. The method of claim 6, wherein the one or more beacons each include connection information for the first device, the connection information being based at least on the third bandwidth configuration, and wherein the one or more beacons are transmitted over each of the identified unrestricted subchannels and over each of the identified restricted sub channels.

9. An apparatus for wireless communication over a transmission channel, the apparatus comprising:
a signal detector;
a processor configured to:
identify a plurality of subchannels of the transmission channel for transmission, the identified plurality of subchannels including one or more restricted subchannels and including one or more unrestricted subchannels;
determine a first bandwidth configuration for the identified restricted subchannels and a second bandwidth configuration for the identified unrestricted subchannels;
scan, in connection with the signal detector, for one or more restricted signals over one or more of the identified restricted subchannels; and
a transmitter configured to transmit a beacon to a wireless device within a duration of the scan, the beacon being transmitted over one or more of the identified unrestricted subchannels.

10. The apparatus of claim 9, the transmitter being further configured to transmit connection information for the apparatus in the beacon, the connection information being based at least on the second bandwidth configuration.

11. The apparatus of claim 9, further comprising:
the processor being further configured to:
detect one or more restricted signals over one or more of the identified restricted subchannels within the duration of the scan;
identify at least one different restricted subchannel for transmission;
determine the first bandwidth configuration for the identified different restricted subchannels; and
scan, in connection with the signal detector, for one or more restricted signals over one or more of the identified different restricted subchannels; and
the transmitter being further configured to transmit a second beacon to the wireless device during the scan over the one or more of the identified different restricted subchannels, the second beacon being transmitted over one or more of the identified unrestricted subchannels.

12. The apparatus of claim 11, wherein the identification of the at least one different restricted subchannel is based on a random channel identification, and wherein the processor is further configured to randomly identify at least one different unrestricted subchannel for transmission.

13. The apparatus of claim 9, further comprising:
the processor being further configured to:
detect one or more restricted signals over one or more of the identified restricted subchannels within the duration of the scanning;
wait for a predetermined duration; and
after waiting the predetermined duration, scan, in connection with the signal detector, for one or more restricted signals over one or more of the identified restricted subchannels; and
the transmitter being further configured to transmit a second beacon to the wireless device within the predetermined duration, the second beacon being transmitted over one or more of the identified unrestricted subchannels.

14. The apparatus of claim 9, wherein if the signal detector does not detect any restricted signals over any of the identified restricted subchannels:
the processor being further configured to determine a third bandwidth configuration for the identified subchannels; and
the transmitter being further configured to transmit one or more beacons over one or more of the identified unrestricted subchannels and over one or more of the identified restricted sub channels.

15. The apparatus of claim 14, the processor being further configured to:
subsequently detect one or more restricted signals over one or more of the identified restricted subchannels; and
identify at least one different subchannel of the transmission channel.

16. The apparatus of claim 14, wherein the one or more beacons each include connection information for the apparatus, the connection information being based at least on the third bandwidth configuration, and wherein the transmitter transmits the one or more beacons over each of the identified unrestricted subchannels and over each of the identified restricted subchannels.

17. An apparatus for wireless communication, comprising:
means for detecting signals;
means for identifying, at a first device, a plurality of subchannels of a transmission channel for transmission, the identified plurality of subchannels including one or more restricted subchannels and including one or more unrestricted subchannels, the means for identifying further determining, at the first device, a first bandwidth configuration for the identified restricted subchannels and a second bandwidth configuration for the identified unrestricted subchannels, and the means for identifying further scanning, by the means for detecting signals, for one or more restricted signals over one or more of the identified restricted subchannels; and
means for transmitting, at the first device, a beacon to a second device within a duration of the scanning, the beacon being transmitted over one or more of the identified unrestricted subchannels.

18. The apparatus of claim 17, the means for transmitting being further configured to transmit connection information for the first device in the beacon, the connection information being based at least on the second bandwidth configuration.

19. The apparatus of claim 17, further comprising:
the means for identifying:
detecting one or more restricted signals over one or more of the identified restricted subchannels within the duration of the scanning;
identifying at least one different restricted subchannel for transmission;
determining the first bandwidth configuration for the identified different restricted subchannels; and
scanning, by the means for detecting signals, for one or more restricted signals over one or more of the identified different restricted subchannels; and
the means for transmitting further transmitting a second beacon to the second device during the scanning over the one or more of the identified different restricted subchannels, the second beacon being transmitted over one or more of the identified unrestricted subchannels.

20. The apparatus of claim 19, the means for identifying further identifying the at least one different restricted subchannel based on a random channel identification and randomly identifying at least one different unrestricted subchannel for transmission.

21. The apparatus of claim 17, further comprising:
the means for identifying further:
detecting one or more restricted signals over one or more of the identified restricted subchannels within the duration of the scanning:
waiting for a predetermined duration; and
after waiting the predetermined duration, scanning, by the means for detecting signals, for one or more restricted signals over one or more of the identified restricted subchannels; and
the means for transmitting further transmitting a second beacon to the second device within the predetermined duration, the second beacon being transmitted over one or more of the identified unrestricted subchannels.

22. The apparatus of claim 17, wherein if the means for detecting signals does not detect any restricted signals over any of the identified restricted subchannels:
the means for identifying further determining a third bandwidth configuration for the identified subchannels; and
the means for transmitting further transmitting one or more beacons over one or more of the identified unrestricted subchannels and over one or more of the identified restricted subchannels.

23. The apparatus of claim 22, wherein the means for identifying:
subsequently detects one or more restricted signals over one or more of the identified restricted subchannels; and
identifies at least one different subchannel of the transmission channel.

24. A non-transitory computer-readable medium comprising code that, when executed, causes an apparatus to perform a method, the method comprising:
identifying, at a first device, a plurality of subchannels of a transmission channel for transmission, the identified plurality of subchannels including one or more restricted subchannels and including one or more unrestricted subchannels;
determining, at the first device, a first bandwidth configuration for the identified restricted subchannels and a second bandwidth configuration for the identified unrestricted subchannels;
scanning, by the first device, for one or more restricted signals over one or more of the identified restricted subchannels; and
transmitting, at the first device, a beacon to a second device within a duration of the scanning, the beacon being transmitted over one or more of the identified unrestricted subchannels.

25. The medium of claim 24, further comprising transmitting connection information for the first device in the beacon, the connection information being based at least on the second bandwidth configuration.

26. The medium of claim 24, further comprising:
detecting, by the first device, one or more restricted signals over one or more of the identified restricted subchannels within the duration of the scanning;
identifying at least one different restricted subchannel for transmission;
determining the first bandwidth configuration for the identified different restricted subchannels;
scanning, by the first device, for one or more restricted signals over one or more of the identified different restricted subchannels; and
transmitting a second beacon to the second device during the scanning over the one or more of the identified different restricted subchannels, the second beacon being transmitted over one or more of the identified unrestricted subchannels.

27. The medium of claim 26, the method further comprising identifying the at least one different restricted subchannel based on a random channel identification and randomly identifying at least one different unrestricted subchannel for transmission.

28. The medium of claim 24, further comprising:
detecting, by the first device, one or more restricted signals over one or more of the identified restricted subchannels within the duration of the scanning;
waiting for a predetermined duration;
after waiting the predetermined duration, scanning, by the first device, for one or more restricted signals over one or more of the identified restricted subchannels; and
transmitting a second beacon to the second device within the predetermined duration, the second beacon being transmitted over one or more of the identified unrestricted subchannels.

29. The medium of claim 24, wherein if the first device does not detect any restricted signals over any of the identified restricted subchannels, the method further comprising:
determining a third bandwidth configuration for the identified subchannels; and
transmitting one or more beacons over one or more of the identified unrestricted subchannels and over one or more of the identified restricted subchannels.

30. The medium of claim 29, further comprising:
subsequently detecting, by the first device, one or more restricted signals over one or more of the identified restricted subchannels; and
identifying at least one different subchannel of the transmission channel.
